(19) United States
(12) Patent Application Publication
(10) Pub. No.: US 2024/0345234 A1
(43) Pub. Date: Oct. 17, 2024

(54) BISTATIC MULTIPLE-INPUT MULTIPLE-OUTPUT (MIMO) RADAR IN CELLULAR NETWORKS

(71) Applicant: QUALCOMM Incorporated, San Diego, CA (US)

(72) Inventors: Weimin DUAN, San Diego, CA (US); Alexandros MANOLAKOS, Athens (GR); Tingfang JI, San Diego, CA (US)

(21) Appl. No.: 18/580,360

(22) PCT Filed: Aug. 24, 2022
(86) PCT No.: PCT/US2022/075387

§ 371 Date: Jan. 18, 2024

(30) Foreign Application Priority Data
Sep. 24, 2021 (GR) 20210100632

(51) Int. Cl. G01S 13/00; G01S 7/02; G01S 13/87

(52) U.S. Cl. CPC G01S 13/003; G01S 7/0232; G01S 13/878

(57) ABSTRACT

Disclosed are techniques for wireless environment sensing. In an aspect, a network node transmits, to a network entity, a capability message including one or more capability parameters indicating one or more capabilities of the network node to participate in bistatic or multistatic multiple-input multiple-output (MIMO) radar sensing operations, receives, from the network entity, a configuration message including one or more configuration parameters configuring the network node to participate in a bistatic or multistatic MIMO radar sensing operation, and performs the bistatic or multistatic MIMO radar sensing operation based on the one or more configuration parameters.

### CROSS-REFERENCE TO RELATED APPLICATIONS

The present Application for Patent claims priority to Greek Patent Application No. 20210100632, entitled “BISTATIC MULTIPLE-INPUT MULTIPLE-OUTPUT (MIMO) RADAR IN CELLULAR NETWORKS,” filed Sep. 24, 2021, and is a national stage application, filed under 35 U.S.C. § 371, of International Patent Application No. PCT/US2022/075387, entitled “BISTATIC MULTIPLE-INPUT MULTIPLE-OUTPUT (MIMO) RADAR IN CELLULAR NETWORKS,” filed Aug. 24, 2022, both of which are assigned to the assignee hereof and expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless environment sensing performed by a network node includes transmitting, to a network entity, a capability message including one or more capability parameters indicating one or more capabilities of the network node to participate in bistatic or multistatic multiple-input multiple-output (MIMO) radar sensing operations; receiving, from the network entity, a configuration message including one or more configuration parameters configuring the network node to participate in a bistatic or multistatic MIMO radar sensing operation; and performing the bistatic or multistatic MIMO radar sensing operation based on the one or more configuration parameters.

In an aspect, a method of environment sensing performed by a network entity includes receiving, from each network node of a plurality of network nodes, a capability message including one or more capability parameters indicating one or more capabilities of the network node to participate in bistatic or multistatic multiple-input multiple-output (MIMO) radar sensing operations; transmitting, to each network node of the plurality of network nodes, a configuration message including one or more configuration parameters configuring the network node to participate in a bistatic or multistatic MIMO radar sensing operation.

In an aspect, a network node includes a memory; at least one transceiver; and at least one processor communicatively coupled to the memory and the at least one transceiver, the at least one processor configured to: transmit, via the at least one transceiver, to a network entity, a capability message including one or more capability parameters indicating one or more capabilities of the network node to participate in bistatic or multistatic multiple-input multiple-output (MIMO) radar sensing operations; receive, via the at least one transceiver, from the network entity, a configuration message including one or more configuration parameters configuring the network node to participate in a bistatic or multistatic MIMO radar sensing operation; and perform the bistatic or multistatic MIMO radar sensing operation based on the one or more configuration parameters.

In an aspect, a network entity includes a memory; at least one transceiver; and at least one processor communicatively coupled to the memory and the at least one transceiver, the at least one processor configured to: receive, via the at least one transceiver, from each network node of a plurality of network nodes, a capability message including one or more capability parameters indicating one or more capabilities of the network node to participate in bistatic or multistatic multiple-input multiple-output (MIMO) radar sensing operations; and transmit, via the at least one transceiver, to each network node of the plurality of network nodes, a configuration message including one or more configuration parameters configuring the network node to participate in a bistatic or multistatic MIMO radar sensing operation.

In an aspect, a network node includes means for transmitting, to a network entity, a capability message including one or more capability parameters indicating one or more capabilities of the network node to participate in bistatic or multistatic multiple-input multiple-output (MIMO) radar sensing operations; means for receiving, from the network entity, a configuration message including one or more configuration parameters configuring the network node to participate in a bistatic or multistatic MIMO radar sensing operation; and means for performing the bistatic or multistatic MIMO radar sensing operation based on the one or more configuration parameters.

In an aspect, a network entity includes means for receiving, from each network node of a plurality of network nodes, a capability message including one or more capability parameters indicating one or more capabilities of the network node to participate in bistatic or multistatic multiple-input multiple-output (MIMO) radar sensing operations; and means for transmitting, to each network node of the plurality of network nodes, a configuration message including one or more configuration parameters configuring the network node to participate in a bistatic or multistatic MIMO radar sensing operation.

In an aspect, a non-transitory computer-readable medium storing computer-executable instructions that, when executed by a network node, cause the network node to: transmit, to a network entity, a capability message including one or more capability parameters indicating one or more capabilities of the network node to participate in bistatic or multistatic multiple-input multiple-output (MIMO) radar sensing operations; receive, from the network entity, a configuration message including one or more configuration parameters configuring the network node to participate in a bistatic or multistatic MIMO radar sensing operation; and perform the bistatic or multistatic MIMO radar sensing operation based on the one or more configuration parameters.

In an aspect, a non-transitory computer-readable medium storing computer-executable instructions that, when executed by a network entity, cause the network entity to: receive, from each network node of a plurality of network nodes, a capability message including one or more capability parameters indicating one or more capabilities of the network node to participate in bistatic or multistatic multiple-input multiple-output (MIMO) radar sensing operations; and transmit, to each network node of the plurality of network nodes, a configuration message including one or more configuration parameters configuring the network node to participate in a bistatic or multistatic MIMO radar sensing operation.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIGS. 4A to 4C illustrate various types of radar.

FIG. 5 is a graph illustrating an example waveform of transmitted and received frequency modulated continuous wave (FMCW) radio frequency (RF) signals, according to aspects of the disclosure.

FIG. 6 illustrates a comparison between a simple chirp waveform and a mmW orthogonal frequency division multiplexing (OFDM) waveform, according to aspects of the disclosure.

FIGS. 7A and 7B illustrate two example multiple-input multiple-output (MIMO) radar configurations with two transmit antennas and multiple receive antennas.

FIGS. 8 and 9 illustrate example methods of environment sensing, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

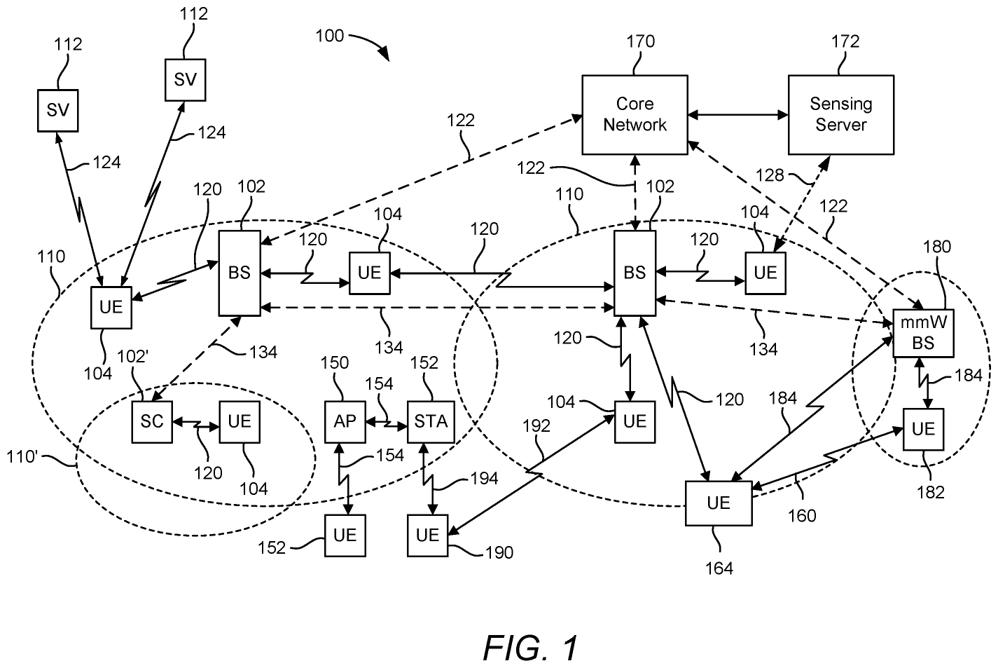

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more sensing servers 172. The sensing server(s) 172 may be part of core network 170 or may be external to core network 170 (e.g., as a remote third-party server). A sensing server 172 may be integrated with a base station 102. A UE 104 may communicate with a sensing server 172 directly or indirectly. For example, a UE 104 may communicate with a sensing server 172 via the base station 102 that is currently serving that UE 104. A UE 104 may also communicate with a sensing server 172 through another path, such as via an application server (not shown), via another network, such as via a wireless local area network (WLAN) access point (AP) (e.g., AP 150 described below), and so on. For signaling purposes, communication between a UE 104 and a sensing server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

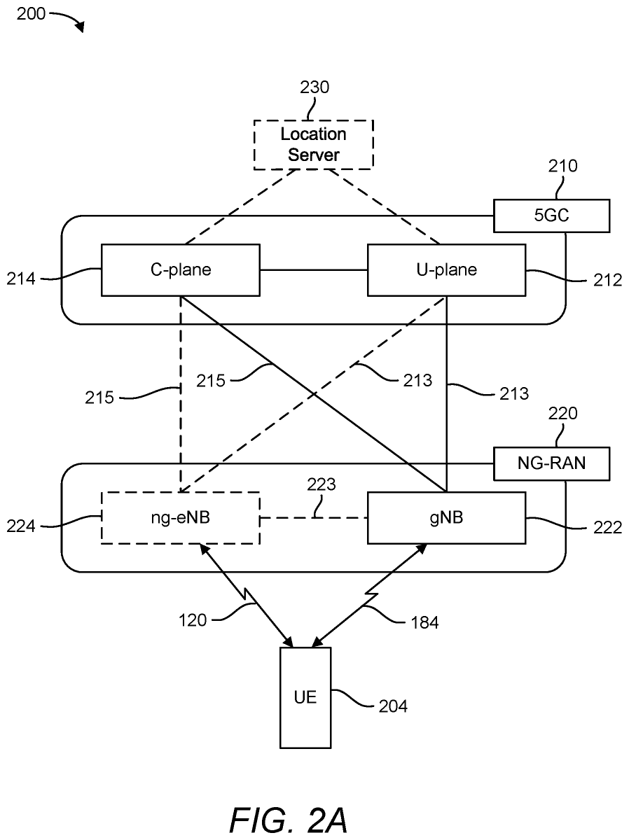

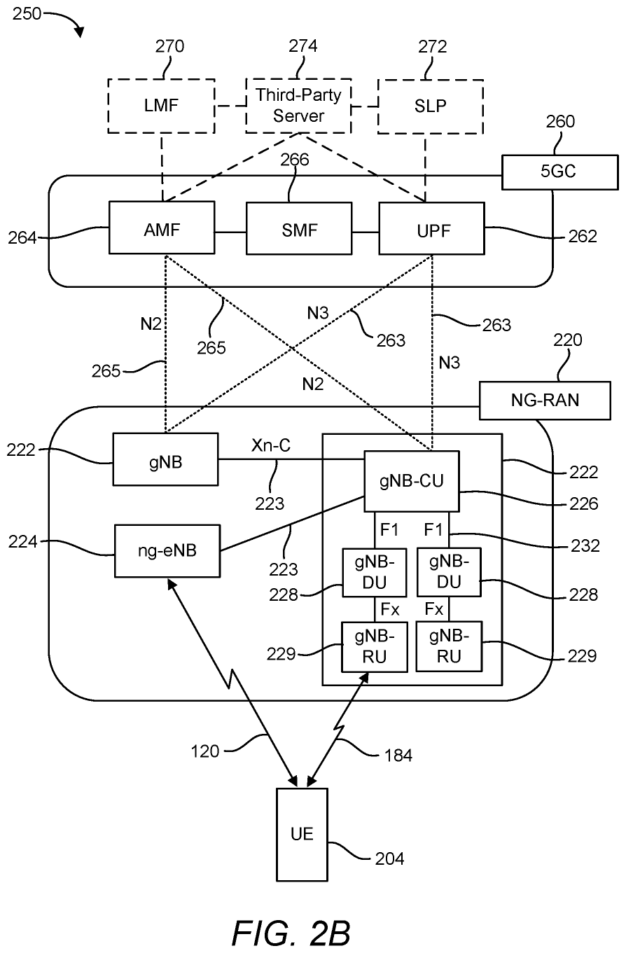

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third-party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as a secure user plane location (SUPL) location platform (SLP) 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. Alternatively, the third-party server 274 may correspond to the sensing server 172. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUS) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

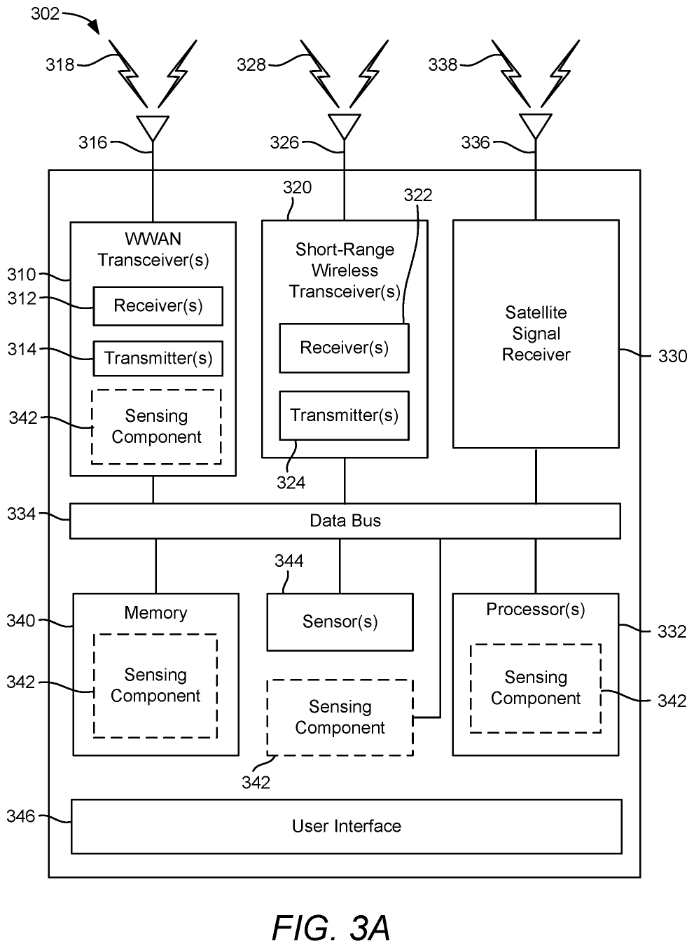

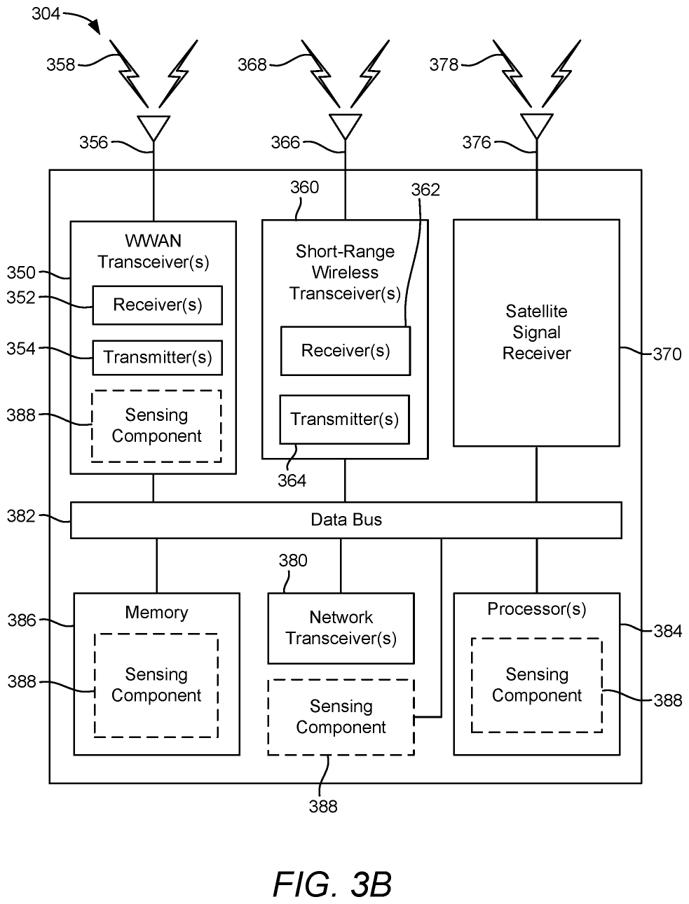

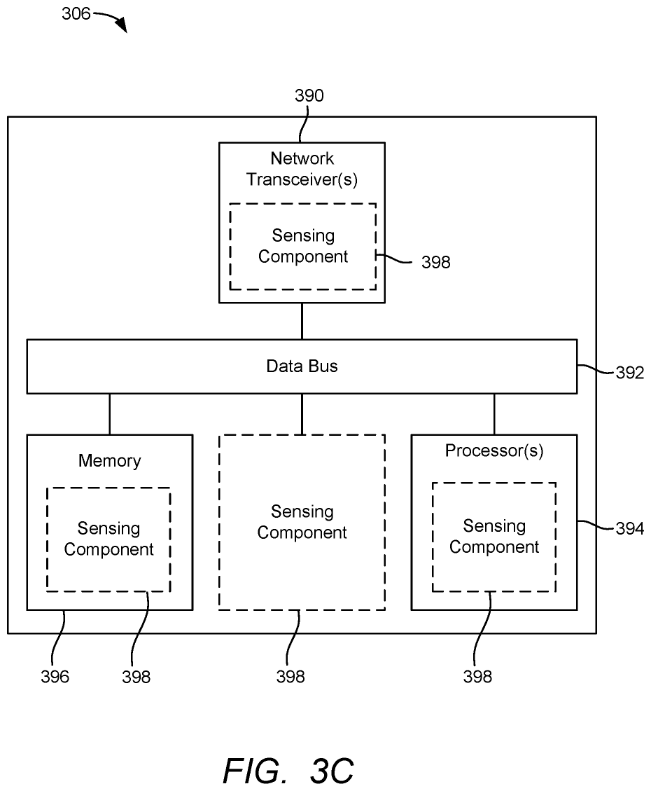

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include sensing component 342, 388, and 398, respectively. The sensing component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the sensing component 342, 388, and 398 may be external to the processors 332, 384, and 394 (e.g., part of a modem processing system, integrated with another processing system, etc.). Alternatively, the sensing component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the sensing component 342, which may be, for example, part of the one or more WWAN transceivers 310, the memory 340, the one or more processors 332, or any combination thereof, or may be a standalone component. FIG. 3B illustrates possible locations of the sensing component 388, which may be, for example, part of the one or more WWAN transceivers 350, the memory 386, the one or more processors 384, or any combination thereof, or may be a standalone component. FIG. 3C illustrates possible locations of the sensing component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the sensing component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

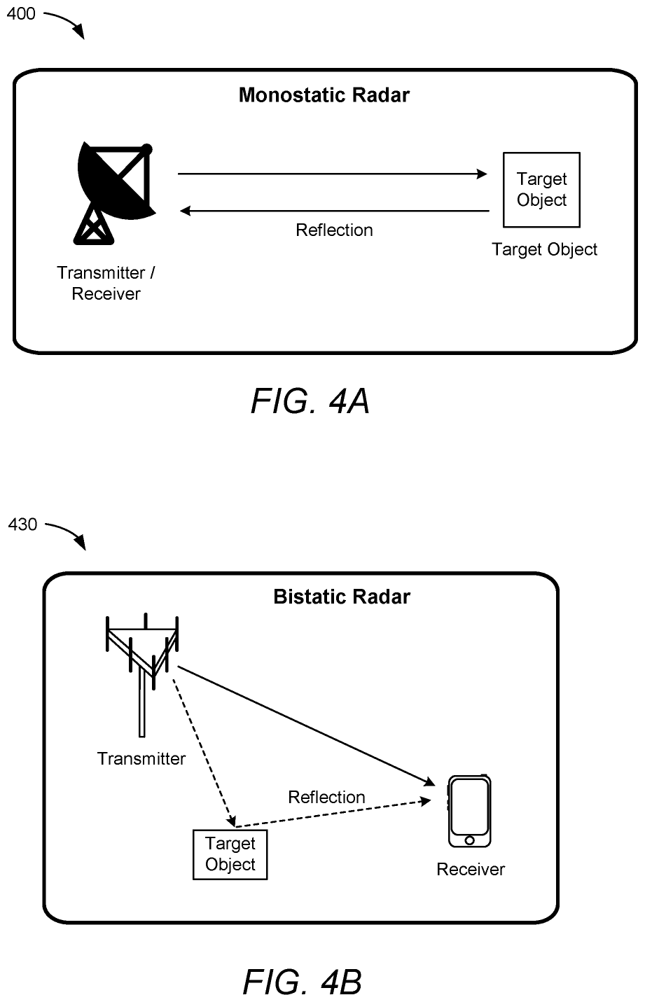

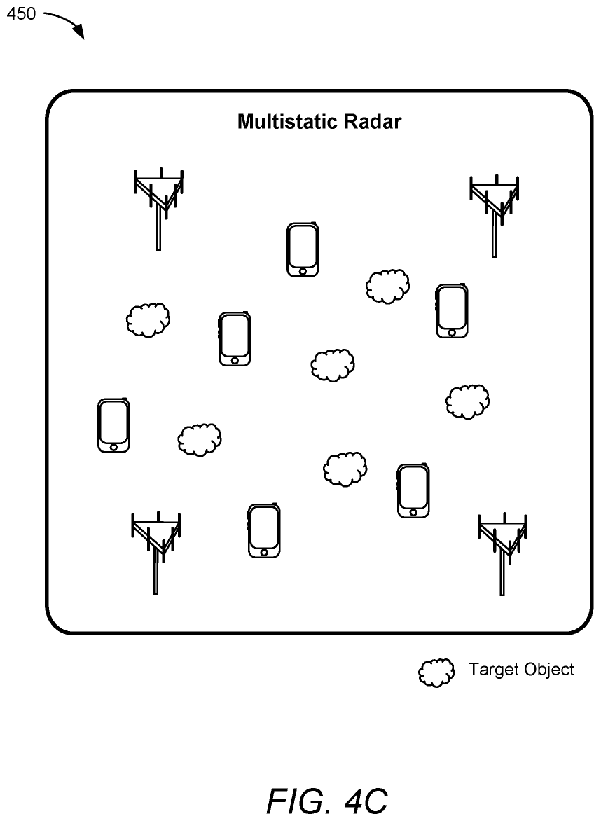

There are different types of radar, in particular, monostatic, bistatic, and multistatic radar (note that bistatic radar is a type of multistatic radar). FIGS. 4A to 4C illustrate these various types of radar. Specifically, FIG. 4A is a diagram 400 illustrating a monostatic radar scenario, FIG. 4B is a diagram 430 illustrating a bistatic radar scenario, and FIG. 4C is a diagram 450 illustrating a multistatic radar scenario. In FIG. 4A, the transmitter and receiver are co-located. This is the typical use case for traditional, or conventional, radar. In FIG. 4B, the transmitter and receiver are not co-located, but rather, are separated. This is the typical use case for wireless communication-based (e.g., WiFi-based, LTE-based, NR-based) RF sensing. Note that while FIG. 4B illustrates using a downlink RF signal as the RF sensing signal, uplink RF signals can also be used as RF sensing signals. In a downlink scenario, as shown, the transmitter is a base station and the receiver is a UE, whereas in an uplink scenario, the transmitter is a UE and the receiver is a base station.

Referring to FIG. 4B in greater detail, the base station transmits RF sensing signals (e.g., PRS) to the UE, but some of the RF sensing signals reflect off a target object. In FIG. 4B, the solid line represents RF sensing signals that followed the direct (or line-of-sight (LOS)) path between the base station and the UE, and the dashed lines represent the RF sensing signals that followed an reflected (or non-line-of-sight (NLOS)) path between the base station and the UE due to reflecting off the target object. The base station may have transmitted multiple RF sensing signals in different directions, some of which followed the direct path and others of which followed the reflected path. Alternatively, the base station may have transmitted a single RF sensing signal in a broad enough beam that a portion of the RF sensing signal followed the direct path and a portion of the RF sensing signal followed the reflected path.

The UE can measure the time of arrival (ToAs) of the RF sensing signals received directly from the base station and the ToAs of the RF sensing signals reflected from the target object to determine the distance, and possibly direction, to the target object. More specifically, based on the difference between the ToA of the direct path, the ToA of the reflected path, and the speed of light, the UE can determine the distance to the target object. In addition, if the UE is capable of receive beamforming, the UE may be able to determine the general direction to the target object as the direction of the receive beam on which the RF sensing signal following the reflected path was received. The UE may then optionally report this information to the transmitting base station, an application server associated with the core network, an external client, a third-party application, or some other entity. Alternatively, the UE may report the ToA measurements to the base station, or other entity, and the base station may determine the distance and, optionally, the direction to the target object.

Note that if the RF sensing signals are uplink RF signals transmitted by the UE to the base station, the base station would perform object detection based on the uplink RF signals just as the UE does based on the downlink RF signals.

Referring now to FIG. 4C, the transmitter and receiver are again not co-located. In this scenario, however, there are multiple transmitters and multiple receivers. This is the typical use case for cellular communication-based (e.g., LTE-based, NR-based) RF sensing. Multistatic radar operates much like the operation of bistatic radar described above with reference to FIG. 4B, except that one transmitter may transmit RF sensing signals to multiple receivers and one receiver may receive RF sensing signals from multiple transmitters.

Possible use cases of multistatic cellular communication-based RF sensing include location detection of device-free objects (i.e., an object that does not itself transmit wireless signals or does not participate in being located). For example, multistatic cellular communication-based RF sensing can be used for environment scanning for self-organization networks (SONs). Currently, in a multistatic radar scenario, all involved base stations either transmit (in which case the involved UEs receive) or receive (in which case the involved UEs transmit).

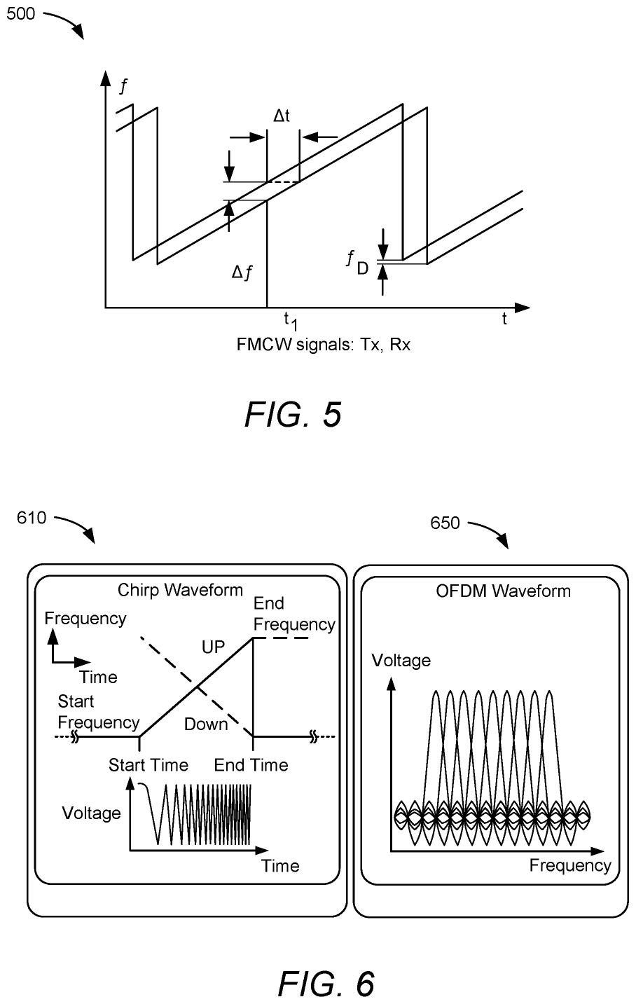

FIG. 5 is a graph 500 illustrating an example waveform of a transmitted and received frequency modulated continuous wave (FMCW) RF signals, according to aspects of the disclosure. FIG. 5 illustrates an example of a sawtooth modulation, which is a common FMCW waveform where range is desired. Range information is mixed with the Doppler velocity using this technique. Modulation can be turned off on alternate scans to identify velocity using unmodulated carrier frequency shift. This allows range and velocity to be determined with one radar set.

As shown in FIG. 5, the received RF waveform (the lower diagonal lines) is simply a delayed replica of the transmitted RF waveform (the upper diagonal lines). The frequency at which the waveforms are transmitted is used to down-convert the received RF waveform to baseband (a signal that has a near-zero frequency range), and the amount of frequency shift between the transmitted RF waveform and the reflected (received) RF waveform increases with the time delay between them. The time delay is thus a measure of range to the target object. For example, a small frequency spread is produced by reflections from a nearby object, whereas a larger frequency spread is produced by reflections from a further object, thereby resulting in a longer time delay between the transmitted and received RF waveforms.

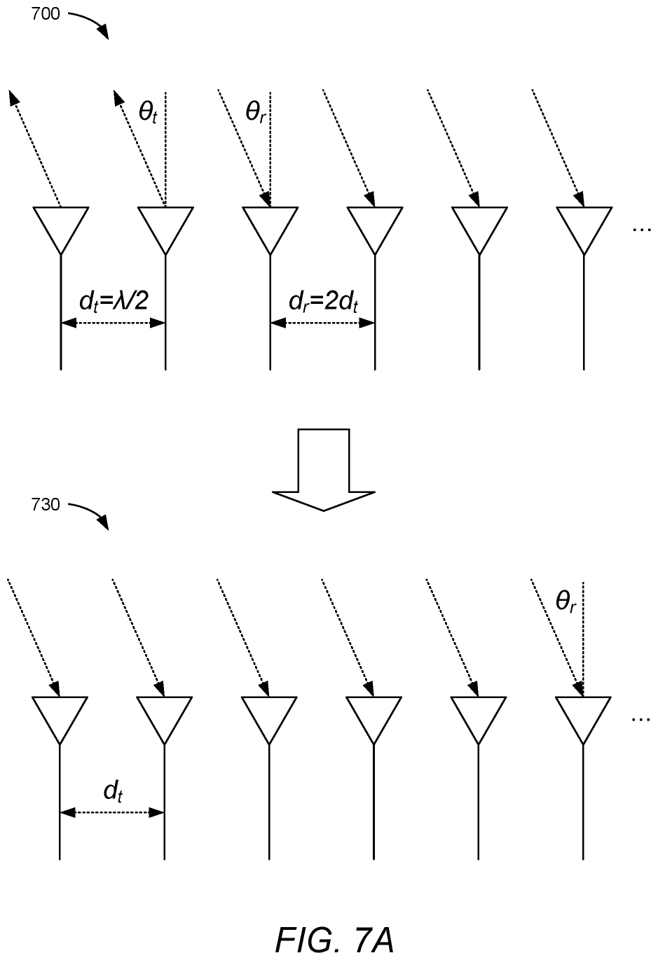

A wireless communication signal (e.g., an OFDM waveform) can be configured for use as a radar signal for environment sensing. Like conventional radar (e.g., FMCW radar), an OFDM-based radar signal can be used to estimate the range (distance), velocity (Doppler), and angle (angle of arrival (AoA)) of a target object. FMCW radar signals are typically formed as a simple chirp waveform. A chirp waveform can be used when the only purpose of the transmitted RF signal is for environmental sensing. However, due to the short wavelength, a more complex OFDM waveform in a mmW frequency band can be used for both communication (e.g., over a 5G network) and environment sensing. FIG. 6 illustrates a comparison between a simple chirp waveform (as used in FMCW radar techniques) and a more complex mmW OFDM waveform, according to aspects of the disclosure. Specifically, FIG. 6 illustrates a diagram 610 of an example chirp waveform and a diagram 650 of an example mmW OFDM waveform.

In radio, MIMO is a method for multiplying the capacity of a radio link using multiple transmission and receiving antennas to exploit multipath propagation. Note, however, that multiple transmission and receiving antennas are not strictly necessary. Rather, MIMO techniques can be used to send and receive more than one data signal simultaneously over the same radio channel by exploiting multipath propagation. In this case, the use of OFDM to encode the channel is responsible for the increase in data capacity.

MIMO radar is a type of radar that is sometimes compared to phased array radar. MIMO radar propagates signals in a fashion similar to multistatic radar (see, e.g., FIG. 4C). However, instead of distributing the radar elements throughout the surveillance area, MIMO radar attempts to enhance the angle resolution with a limited number of antennas.

In a traditional phased array system, additional antennas and related hardware are needed to improve spatial resolution. MIMO radar systems transmit mutually orthogonal signals from multiple transmit antennas, and these waveforms can be extracted from each of the receive antennas by a set of matched filters. For example, if a MIMO radar system has three transmit antennas and four receive antennas, 12 signals can be extracted from the receiver because of the orthogonality of the transmitted signals. That is, a 12-element virtual antenna array is created using only seven antennas by conducting digital signal processing on the received signals, thereby obtaining a finer spatial resolution compared with its phased array counterpart.

To achieve high angular resolution with a limited number of antennas (which is beneficial due to the lower cost and smaller size of the antenna panel), the range and Doppler of targets can be estimated by using a single receive antenna. However, to estimate the angle parameters of a target, an array of receive antennas is needed. Thus, for conventional phased-array radar (not MIMO radar), the small antenna package size (i.e., small number of antennas) results in low angular resolution.

However, MIMO radar can synthesize virtual arrays with a large aperture using only a small number of transmit and receive antennas. In MIMO radar, the transmit antennas transmit different waveforms that are orthogonal to each other. At each receive antenna, the contribution of each transmit antenna is extracted by exploiting the waveform orthogonality. Thus, for Mₜ transmit antennas and Mᵣ receive antennas, a virtual array with Mₜ*Mᵣ elements can be synthesized.

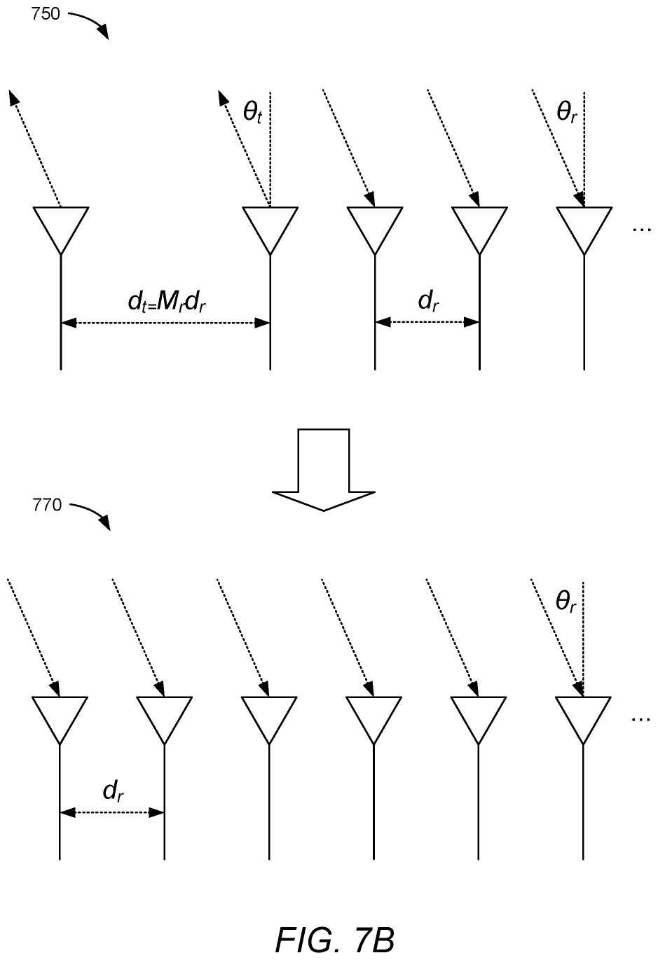

FIGS. 7A and 7B illustrate two example MIMO radar configurations with Mₜ=2 transmit antennas and Mᵣ receive antennas. Specifically, FIG. 7A illustrates an interleaved scenario, where the transmit antennas simultaneously transmit different waveforms that are interleaved with each other. As shown in FIG. 7A, the distance between the transmit antennas dₜ=λ/2 (where λ is the wavelength) and the distance between the receive antennas dᵣ=2dₜ, or twice the distance between the transmit antennas. In FIG. 7A, diagram 700 illustrates the physical antenna configuration, in which there are Mₜ=2 transmit antennas (the two leftmost antennas) and at least Mᵣ=4 receive antennas (there may be more receive antennas, as illustrated by the ellipses). Diagram 730 illustrates the logical, or virtual, result of the physical antenna configuration illustrated in diagram 700.

FIG. 7B illustrates a stacked scenario, where the transmit antennas simultaneously transmit different waveforms that are stacked on each other. As shown in FIG. 7B, the distance between the transmit antennas dₜ=Mᵣdᵣ, and the distance between the receive antennas dᵣ=λ/2 (where λ is the wavelength). In FIG. 7B, diagram 750 illustrates the physical antenna configuration, in which there are Mₜ=2 transmit antennas (the two leftmost antennas) and at least Mᵣ=3 receive antennas (there may be more receive antennas, as illustrated by the ellipses). Diagram 770 illustrates the logical, or virtual, result of the physical antenna configuration illustrated in diagram 750. Specifically, the first physical transmit signal translates to the first three virtual receive signals, and the second physical transmit signal translates to the second three virtual receive signals. For both array configurations illustrated in FIGS. 7A and 7B, the synthetic virtual arrays are equivalent to uniform linear arrays (ULAs), with Mₜ*Mᵣ elements and a spacing of dₜ when θₜ=θᵣ.

In greater detail, for a MIMO radar having a transmit antenna array of M antennas and a receive antenna array of N antennas, the orthogonal signals emitted by the M transmit antennas are denoted as ϕ(t)=[ϕ₁(t), . . . , ϕ_{M}(t)], where ϕ represents the waveform at time t and M is the index of the transmit antenna. The N×1 snapshot vector received by the receive antenna array can be modeled as X(t)=Xₛ(t)+Xᵢ(t)+n(t), where Xₛ(t), Xᵢ(t), and n(t) are the target/source signal, the interference/jamming, and noise at time t, respectively. Xₛ(t)=βₛ(α^{T}(θ)ϕ(t))b(θ), where βₛ, α(θ), and b(θ), are the reflection coefficient, the transmit steering vector, and the receive steering vector, respectively. Note that if orthogonal waveforms ϕ(t) are used, the above MIMO radar formulation does not allow for coherent processing at the transmit array and, therefore, it lacks robustness against noise and radar cross section (RCS) fading.

At the receiver side, after match filtering, the MN×1 virtual data vector is y=yₛ+yᵢ₊ₙ, where the term yₛ=βₛα(θ)⊗b(θ) is the target signal component, and yᵢ₊ₙ is the interference and noise, and which indicates an array with an MN effective aperture can be obtained by using M+N antennas. The aperture extension of the resulting virtual array due to the orthogonality of the transmitted waveforms is traditionally referred to as “waveform diversity” for MIMO radar.

Referring to waveform orthogonality for MIMO radar more specifically, waveform orthogonality is desirable because virtual array synthesis in MIMO radar relies on the separability of the transmit signals of the different antennas. The separation is much easier when the transmit signals of the different antennas are orthogonal to each other.

There are different ways to achieve waveform orthogonality, specifically, via time domain multiplex (TDM), Doppler domain multiplex (DDM), or frequency domain multiplex (FDM). For TDM waveform orthogonality, only one transmit antenna is scheduled to transmit in each time slot. For DDM waveform orthogonality, all transmit antennas simultaneously transmit the same radar waveform after multiplying it with a phase code that is different for each antenna and changes between pulses. For waveform orthogonality via FDM, the transmitted signals are modulated by different carrier frequencies.

In conventional bistatic radar, the transmitting beam and the receiving beam need to illuminate the same target simultaneously to solve the space synchronization problem. This problem is referred to as “pulse chasing.” One solution would be beam-coordination across nodes in a cellular network. However, the beam coordination could still be limited for the problem of multi-target identification and localization. Another solution would be MIMO bistatic radar: the combination of MIMO radar and bistatic radar. This scheme has the advantages of both bistatic radar and MIMO radar. With MIMO radar, the whole space can be covered by the electromagnetic waves that are transmitted by the transmit array. This is because the array beampattern (also referred to as the MIMO radar array factor) is omnidirectional. It is indicated that the product of the number of receive and transmit elements minus-one targets can be identified in the case of independently distributed targets by exploiting the uncorrelation of the reflection coefficients of the targets. The waveform diversity afforded by MIMO radar enables a much-improved parameter identifiability over its phased-array counterpart; specifically, the maximum number of targets that can be uniquely identified by the MIMO radar is up to Mₜ times that of its phased-array counterpart.

Due to larger and larger bandwidth allocated for cellular communications systems (e.g., 5G and beyond) and more and more use cases being introduced, joint communication and RF sensing is an increasingly important feature for future cellular communications systems. The base stations and/or UEs in a cellular system could serve as the transmitters and receivers for bistatic and multistatic radar to enable RF sensing with the cellular RF spectrum resources. Compared with a monostatic radar solution (see, e.g., FIG. 4A), where the transmitter and receiver are co-located in a single base station or UE site, the self-interference issue would be solved, as the transmitter and receiver are separated by a distance comparable to the expected target distance in the bistatic/multistatic radar solution.

To enable bistatic and multistatic MIMO radar in cellular networks, real-time knowledge of the radar transmitter and the waveform is needed at the radar receiver side. However, different waveform orthogonality schemes (e.g., TDM, DDM, FDM) have different challenges, as discussed further below. Accordingly, the present disclosure proposes various solutions to enable bistatic and multistatic MIMO radar in cellular networks.

A first technique described herein relates to signaling the MIMO radar transmitter configuration (parameters) to the MIMO radar receiver (for a bistatic or multistatic scenario, where the transmitter and receiver are not co-located). More specifically, to enable bistatic/multistatic MIMO radar in a cellular system, the transmission parameters at the MIMO radar transmitter (e.g., a base station or UE) need to be signaled to the MIMO radar receiver (e.g., another base station or UE). Similar to positioning techniques in NR, a server could be defined as the functional facility, or node, that configures and controls the transmitter and receiver's transmission and reception parameters. Such a server (referred to as, e.g., a “radar server” or a “sensing server”) could be in the core network (e.g., 5GC 210/260) or in the RAN (e.g., NG-RAN 220). Alternatively, it may be external to both the RAN and the core network, such as sensing server 172.

The following parameters would need to be configured to enable bistatic or multistatic MIMO radar. First, the MIMO configuration across the network would needs to be indicated. This would include configuring one or multiple network nodes (e.g., one or more base stations, one or more UEs, or both) as MIMO radar transmitters and one or multiple network nodes (e.g., one or more base stations, one or more UEs, or both) as MIMO radar receivers. In addition, the radar transmitters and receivers should be associated with the respective network nodes' identifiers (e.g., TRP IDs, UE IDs).

A second parameter that needs to be configured to the MIMO radar transmitters and receivers is the waveform orthogonality scheme (e.g., TDM, DDM, FDM) applied in the MIMO radar. A third parameter is the radar signal type (e.g., FMCW, OFDM, etc.) and the related basic parameters. Fourth would be the parameters defining the waveform transmitted by each MIMO radar transmit antenna. This is because, as described above, MIMO radar requires waveform orthogonality among the waveforms transmitted by each MIMO radar transmit antenna.

Note that for different types of radar signals and waveform orthogonality schemes, the above parameters could be different.

There are various considerations related to achieving waveform orthogonality via TDM. As noted above, in a TDM orthogonality scheme, only one transmit antenna is scheduled to transmit in each time interval. This presents various challenges. For example, for a moving target, the switching delays of the transmit antennas introduces target phase migration from pulse to pulse, resulting in the virtual array pattern being distorted. Accordingly, as a first technique to address this issue, the involved network nodes (e.g., base stations and/or UEs) report their capabilities regarding their antenna switching delays to the network (e.g., sensing server 172). The network can then select one or multiple network nodes as the MIMO radar transmitters, at least partially based on the network nodes' reported antenna switching delay. For example, the base station(s) and/or UE(s) with antenna switching delays less than some threshold could be selected as the MIMO radar transmitter(s) for the high-speed target detection.

As a second technique to address the issue with TDM orthogonality, the MIMO radar receivers could compensate for the phase migration before the angle determination (estimation) using the MIMO radar. More specifically, the phase-shift value could be estimated after each target value has been estimated. For example, the target's velocity could be estimated based on a 2D FFT with a single receive antenna. In various aspects, the network may signal the target speed estimation to the MIMO radar receiver(s). The target's speed may be estimated by another network entity and reported to the network.

There are also various considerations related to achieving waveform orthogonality via DDM. As noted above, in a DDM orthogonality scheme, all transmit antennas simultaneously transmit the same radar waveform that is multiplied with a phase code that is different for each antenna and changes between pulses. This can be represented as xₘ(n)=e^{j2πα}^{ₘ}⁽ⁿ⁾, where m=1, 2, . . . , Mₜ and n=1, 2, . . . , N, and where Mₜ is the number of transmit antennas and n is the radar pulse index.

As a first technique when implementing DDM orthogonality, the network can configure and signal the phase code to the MIMO radar transmitter(s) and receiver(s). As a second technique, the network can configure the phase code, at least partially, according to the base station(s) and/or UE(s)' capabilities regarding the number of antennas that could transmit the signal simultaneously. Note that given the code length, the number of phase codes with good correlation properties will be limited. In addition, the larger the number of antennas supporting simultaneously signal transmission, the larger the code length that could be supported by the MIMO radar.

There are also various considerations related to achieving waveform orthogonality via FDM. As noted above, in an FDM orthogonality scheme, the transmitted signals are modulated by different carrier frequencies. If the differences between all offset frequencies f_{off,m} are larger than twice the cutoff frequency of the antialiasing bandpass filter (BPF) f_{max,b}, the transmitted signals can be separated at the receiver side.

As a first technique related to FDM orthogonality, for different waveform types and different time and/or frequency resource configurations, the determination of f_{max,b} could be different. The principle is to determine f_{max,b} to avoid ambiguous parameter estimation, such as range and Doppler, which may need to be evaluated by the specific ambiguous functions.

As a second technique related to FDM orthogonality, the number of carrier frequencies supported by the base station(s) and/or UE(s) may be limited to the corresponding capabilities. As such, the base station(s) and/or UE(s) may report their capabilities to support the maximum number of carrier frequencies. Alternatively, the base station(s) and/or UE(s) may report their respective lists of supported carrier frequencies. This would include the supported carrier frequencies for both transmission and reception.

After being configured as described above, the involved base station(s) and/or UE(s) may perform a MIMO radar sensing operation based on the configured parameters to detect one or more target objects in the environment. As will be appreciated, the involved base station(s) and/or UE(s) may at times be transmitters and at other times receivers, depending on their capabilities and the configuration received from the network.

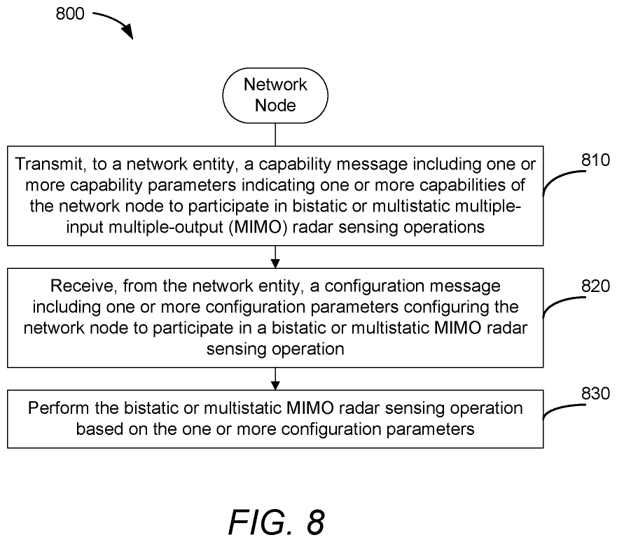

FIG. 8 illustrates an example method 800 of wireless environment sensing, according to aspects of the disclosure. In an aspect, method 800 may be performed by a network node (e.g., any of the UEs or base stations described herein).

At 810, the network node transmits, to a network entity (e.g., a sensing server), a capability message including one or more capability parameters indicating one or more capabilities of the network node to participate in bistatic or multistatic MIMO radar sensing operations. In an aspect, where the network node is a UE, operation 810 may be performed by the one or more WWAN transceivers 310, the one or more short-range wireless transceiver 320, the one or more processors 332, memory 340, and/or sensing component 342, any or all of which may be considered means for performing this operation. In an aspect, where the network node is a base station, operation 810 may be performed by the one or more WWAN transceivers 350, the one or more short-range wireless transceiver 360, the one or more processors 384, memory 386, and/or sensing component 388, any or all of which may be considered means for performing this operation.

At 820, the network node receives, from the network entity, a configuration message including one or more configuration parameters configuring the network node to participate in a bistatic or multistatic MIMO radar sensing operation. In an aspect, where the network node is a UE, operation 820 may be performed by the one or more WWAN transceivers 310, the one or more short-range wireless transceiver 320, the one or more processors 332, memory 340, and/or sensing component 342, any or all of which may be considered means for performing this operation. In an aspect, where the network node is a base station, operation 820 may be performed by the one or more WWAN transceivers 350, the one or more short-range wireless transceiver 360, the one or more processors 384, memory 386, and/or sensing component 388, any or all of which may be considered means for performing this operation.

At 830, the network node performs the bistatic or multistatic MIMO radar sensing operation based on the one or more configuration parameters. In an aspect, where the network node is a UE, operation 830 may be performed by the one or more WWAN transceivers 310, the one or more short-range wireless transceiver 320, the one or more processors 332, memory 340, and/or sensing component 342, any or all of which may be considered means for performing this operation. In an aspect, where the network node is a base station, operation 830 may be performed by the one or more WWAN transceivers 350, the one or more short-range wireless transceiver 360, the one or more processors 384, memory 386, and/or sensing component 388, any or all of which may be considered means for performing this operation.

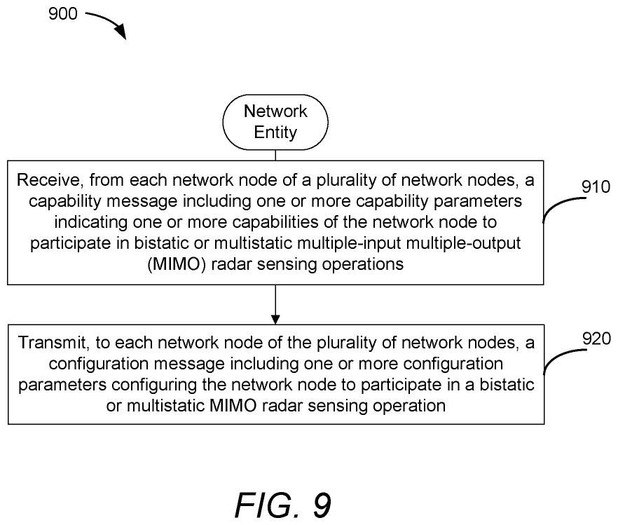

FIG. 9 illustrates an example method 900 of environment sensing, according to aspects of the disclosure. In an aspect, method 900 may be performed by a network entity (e.g., a sensing server).

At 910, the network entity receives, from each network node of a plurality of network nodes, a capability message including one or more capability parameters indicating one or more capabilities of the network node to participate in bistatic or multistatic MIMO radar sensing operations. In an aspect, where the network entity is a component of the RAN, operation 910 may be performed by the one or more WWAN transceivers 350, the one or more short-range wireless transceiver 360, the one or more processors 384, memory 386, and/or sensing component 388, any or all of which may be considered means for performing this operation. In an aspect, where the network entity is a component of the core network, or external to the core network, operation 910 may be performed by the one or more network transceivers 390, the one or more processors 394, memory 396, and/or sensing component 398, any or all of which may be considered means for performing this operation.

At 920, the network entity transmits, to each network node of the plurality of network nodes, a configuration message including one or more configuration parameters configuring the network node to participate in a bistatic or multistatic MIMO radar sensing operation. In an aspect, where the network entity is a component of the RAN, operation 920 may be performed by the one or more WWAN transceivers 350, the one or more short-range wireless transceiver 360, the one or more processors 384, memory 386, and/or sensing component 388, any or all of which may be considered means for performing this operation. In an aspect, where the network entity is a component of the core network, or external to the core network, operation 920 may be performed by the one or more network transceivers 390, the one or more processors 394, memory 396, and/or sensing component 398, any or all of which may be considered means for performing this operation.

As will be appreciated, a technical advantage of the methods 800 and 900 is configuring network nodes to participate in bistatic or multistatic MIMO radar sensing operations based on the capabilities of the network nodes.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless environment sensing performed by a network node, comprising: transmitting, to a network entity, a capability message including one or more capability parameters indicating one or more capabilities of the network node to participate in bistatic or multistatic multiple-input multiple-output (MIMO) radar sensing operations; receiving, from the network entity, a configuration message including one or more configuration parameters configuring the network node to participate in a bistatic or multistatic MIMO radar sensing operation; and performing the bistatic or multistatic MIMO radar sensing operation based on the one or more configuration parameters.

Clause 2. The method of clause 1, wherein the one or more configuration parameters comprise one or more transmission parameters for MIMO radar signals to be transmitted during the bistatic or multistatic MIMO radar sensing operation.

Clause 3. The method of clause 2, wherein the one or more transmission parameters comprise: a type of orthogonality of the MIMO radar signals, a type of the MIMO radar signals, one or more parameters defining a waveform of each of the MIMO radar signals, or any combination thereof.

Clause 4. The method of clause 3, wherein the type of the MIMO radar signals comprises: frequency modulated continuous wave (FMCW) MIMO radar signals, or orthogonal frequency division multiplexing (OFDM) MIMO radar signals.

Clause 5. The method of any of clauses 3 to 4, wherein the type of orthogonality comprises time domain multiplex (TDM) orthogonality.

Clause 6. The method of clause 5, wherein: the one or more capability parameters indicating the one or more capabilities of the network node comprise at least one capability parameter indicating an antenna switching delay of the network node, and the one or more configuration parameters comprise an indication, based on the type of orthogonality comprising TDM orthogonality and the antenna switching delay of the network node being less than a threshold, that the network node is expected to transmit the MIMO radar signals.

Clause 7. The method of any of clauses 5 to 6, wherein: the one or more configuration parameters comprise an indication that the network node is expected to receive the MIMO radar signals, and the network node is expected to compensate, based on the type of orthogonality comprising TDM orthogonality, for phase shift migration before angle estimation.

Clause 8. The method of any of clauses 3 to 7, wherein the type of orthogonality comprises Doppler domain multiplex (DDM) orthogonality.

Clause 9. The method of clause 8, wherein, based on the type of orthogonality comprising DDM orthogonality, the one or more transmission parameters comprise a phase code for each of the MIMO radar signals.

Clause 10. The method of any of clauses 8 to 9, wherein, based on the type of orthogonality comprising DDM orthogonality, a phase code for each of the MIMO radar signals is configured, at least in part, based on a capability of the network node related to a number of antennas of the network node capable of simultaneously transmitting the MIMO radar signals.

Clause 11. The method of any of clauses 3 to 10, wherein the type of orthogonality comprises frequency domain multiplex (FDM) orthogonality.

Clause 12. The method of clause 11, wherein: the one or more configuration parameters comprise an indication that the network node is expected to receive the MIMO radar signals, and based on the type of orthogonality comprising FDM orthogonality, a determination of a cutoff frequency for an antialiasing band pass filter (BPF) is based on a type of waveform of the MIMO radar signals and time resources, frequency resources, or both on which the MIMO radar signals are transmitted.

Clause 13. The method of any of clauses 11 to 12, wherein: the one or more capability parameters indicating the one or more capabilities of the network node include at least one capability parameters indicating a number of carrier frequencies supported by the network node.

Clause 14. The method of any of clauses 1 to 13, wherein the one or more configuration parameters comprise: a network identifier for each of one or more second network nodes involved in the bistatic or multistatic MIMO radar sensing operation, and an association, for each second network node of the one or more second network nodes, between the network identifier of the second network node and an indication of whether the second network node is a MIMO radar receiver network node or a MIMO radar transmitter network node for the bistatic or multistatic MIMO radar sensing operation.

Clause 15. The method of any of clauses 1 to 14, wherein: the one or more configuration parameters comprise an indication that the network node is expected to transmit MIMO radar signals for the bistatic or multistatic MIMO radar sensing operation, and performing the bistatic or multistatic MIMO radar sensing operation comprises transmitting MIMO radar signals to at least one MIMO radar receiver network node.

Clause 16. The method of any of clauses 1 to 14, wherein: the one or more configuration parameters comprise an indication that the network node is expected to receive MIMO radar signals for the bistatic or multistatic MIMO radar sensing operation, and performing the bistatic or multistatic MIMO radar sensing operation comprises receiving the MIMO radar signals from at least one MIMO radar transmitter network node.

Clause 17. The method of any of clauses 1 to 16, wherein: the network node is a user equipment (UE), or the network node is a base station.

Clause 18. A method of environment sensing performed by a network entity, comprising: receiving, from each network node of a plurality of network nodes, a capability message including one or more capability parameters indicating one or more capabilities of the network node to participate in bistatic or multistatic multiple-input multiple-output (MIMO) radar sensing operations; and transmitting, to each network node of the plurality of network nodes, a configuration message including one or more configuration parameters configuring the network node to participate in a bistatic or multistatic MIMO radar sensing operation.

Clause 19. The method of clause 18, further comprising: selecting at least one network node of the plurality of network nodes as a MIMO radar transmitter network node based on the one or more capability parameters indicating the one or more capabilities of the at least one network node, wherein the one or more configuration parameters comprise an indication that the at least one network node is expected to transmit MIMO radar signals.

Clause 20. The method of any of clauses 18 to 19, further comprising: selecting at least one network node of the plurality of network nodes as a MIMO radar receiver network node based on the one or more capability parameters indicating the one or more capabilities of the at least one network node, wherein the one or more configuration parameters comprise an indication that the at least one network node is expected to receive MIMO radar signals.

Clause 21. The method of any of clauses 18 to 20, wherein: the network entity is an entity in a radio access network (RAN), the network entity is an entity in a core network, or the network entity is an entity external to the core network.

Clause 22. A network node, comprising: a memory; at least one transceiver; and at least one processor communicatively coupled to the memory and the at least one transceiver, the at least one processor configured to: transmit, via the at least one transceiver, to a network entity, a capability message including one or more capability parameters indicating one or more capabilities of the network node to participate in bistatic or multistatic multiple-input multiple-output (MIMO) radar sensing operations; receive, via the at least one transceiver, from the network entity, a configuration message including one or more configuration parameters configuring the network node to participate in a bistatic or multistatic MIMO radar sensing operation; and perform the bistatic or multistatic MIMO radar sensing operation based on the one or more configuration parameters.

Clause 23. The network node of clause 22, wherein the one or more configuration parameters comprise one or more transmission parameters for MIMO radar signals to be transmitted during the bistatic or multistatic MIMO radar sensing operation.

Clause 24. The network node of clause 23, wherein the one or more transmission parameters comprise: a type of orthogonality of the MIMO radar signals, a type of the MIMO radar signals, one or more parameters defining a waveform of each of the MIMO radar signals, or any combination thereof.

Clause 25. The network node of clause 24, wherein the type of the MIMO radar signals comprises: frequency modulated continuous wave (FMCW) MIMO radar signals, or orthogonal frequency division multiplexing (OFDM) MIMO radar signals.

Clause 26. The network node of any of clauses 24 to 25, wherein the type of orthogonality comprises time domain multiplex (TDM) orthogonality.

Clause 27. The network node of clause 26, wherein: the one or more capability parameters indicating the one or more capabilities of the network node comprise at least one capability parameter indicating an antenna switching delay of the network node, and the one or more configuration parameters comprise an indication, based on the type of orthogonality comprising TDM orthogonality and the antenna switching delay of the network node being less than a threshold, that the network node is expected to transmit the MIMO radar signals.

Clause 28. The network node of any of clauses 26 to 27, wherein: the one or more configuration parameters comprise an indication that the network node is expected to receive the MIMO radar signals, and the network node is expected to compensate, based on the type of orthogonality comprising TDM orthogonality, for phase shift migration before angle estimation.

Clause 29. The network node of any of clauses 24 to 28, wherein the type of orthogonality comprises Doppler domain multiplex (DDM) orthogonality.

Clause 30. The network node of clause 29, wherein, based on the type of orthogonality comprising DDM orthogonality, the one or more transmission parameters comprise a phase code for each of the MIMO radar signals.

Clause 31. The network node of any of clauses 29 to 30, wherein, based on the type of orthogonality comprising DDM orthogonality, a phase code for each of the MIMO radar signals is configured, at least in part, based on a capability of the network node related to a number of antennas of the network node capable of simultaneously transmitting the MIMO radar signals.

Clause 32. The network node of any of clauses 24 to 31, wherein the type of orthogonality comprises frequency domain multiplex (FDM) orthogonality.

Clause 33. The network node of clause 32, wherein: the one or more configuration parameters comprise an indication that the network node is expected to receive the MIMO radar signals, and based on the type of orthogonality comprising FDM orthogonality, a determination of a cutoff frequency for an antialiasing band pass filter (BPF) is based on a type of waveform of the MIMO radar signals and time resources, frequency resources, or both on which the MIMO radar signals are transmitted.

Clause 34. The network node of any of clauses 32 to 33, wherein: the one or more capability parameters indicating the one or more capabilities of the network node include at least one capability parameters indicating a number of carrier frequencies supported by the network node.

Clause 35. The network node of clause 22, wherein the one or more configuration parameters comprise: a network identifier for each of one or more second network nodes involved in the bistatic or multistatic MIMO radar sensing operation, and an association, for each second network node of the one or more second network nodes, between the network identifier of the second network node and an indication of whether the second network node is a MIMO radar receiver network node or a MIMO radar transmitter network node for the bistatic or multistatic MIMO radar sensing operation.

Clause 36. The network node of any of clauses 22 to 35, wherein: the one or more configuration parameters comprise an indication that the network node is expected to transmit MIMO radar signals for the bistatic or multistatic MIMO radar sensing operation, and performing the bistatic or multistatic MIMO radar sensing operation comprises transmitting MIMO radar signals to at least one MIMO radar receiver network node.

Clause 37. The network node of any of clauses 22 to 35, wherein: the one or more configuration parameters comprise an indication that the network node is expected to receive MIMO radar signals for the bistatic or multistatic MIMO radar sensing operation, and performing the bistatic or multistatic MIMO radar sensing operation comprises receiving the MIMO radar signals from at least one MIMO radar transmitter network node.

Clause 38. The network node of any of clauses 22 to 37, wherein: the network node is a user equipment (UE), or the network node is a base station.

Clause 39. A network entity, comprising: a memory; at least one transceiver; and at least one processor communicatively coupled to the memory and the at least one transceiver, the at least one processor configured to: receive, via the at least one transceiver, from each network node of a plurality of network nodes, a capability message including one or more capability parameters indicating one or more capabilities of the network node to participate in bistatic or multistatic multiple-input multiple-output (MIMO) radar sensing operations; and transmit, via the at least one transceiver, to each network node of the plurality of network nodes, a configuration message including one or more configuration parameters configuring the network node to participate in a bistatic or multistatic MIMO radar sensing operation.

Clause 40. The network entity of clause 39, wherein the at least one processor is further configured to: select at least one network node of the plurality of network nodes as a MIMO radar transmitter network node based on the one or more capability parameters indicating the one or more capabilities of the at least one network node, wherein the one or more configuration parameters comprise an indication that the at least one network node is expected to transmit MIMO radar signals.

Clause 41. The network entity of any of clauses 39 to 40, wherein the at least one processor is further configured to: select at least one network node of the plurality of network nodes as a MIMO radar receiver network node based on the one or more capability parameters indicating the one or more capabilities of the at least one network node, wherein the one or more configuration parameters comprise an indication that the at least one network node is expected to receive MIMO radar signals.

Clause 42. The network entity of any of clauses 39 to 41, wherein: the network entity is an entity in a radio access network (RAN), the network entity is an entity in a core network, or the network entity is an entity external to the core network.

Clause 43. A network node, comprising: means for transmitting, to a network entity, a capability message including one or more capability parameters indicating one or more capabilities of the network node to participate in bistatic or multistatic multiple-input multiple-output (MIMO) radar sensing operations; means for receiving, from the network entity, a configuration message including one or more configuration parameters configuring the network node to participate in a bistatic or multistatic MIMO radar sensing operation; and means for performing the bistatic or multistatic MIMO radar sensing operation based on the one or more configuration parameters.

Clause 44. The network node of clause 43, wherein the one or more configuration parameters comprise one or more transmission parameters for MIMO radar signals to be transmitted during the bistatic or multistatic MIMO radar sensing operation.

Clause 45. The network node of clause 44, wherein the one or more transmission parameters comprise: a type of orthogonality of the MIMO radar signals, a type of the MIMO radar signals, one or more parameters defining a waveform of each of the MIMO radar signals, or any combination thereof.

Clause 46. The network node of clause 45, wherein the type of the MIMO radar signals comprises: frequency modulated continuous wave (FMCW) MIMO radar signals, or orthogonal frequency division multiplexing (OFDM) MIMO radar signals.

Clause 47. The network node of any of clauses 45 to 46, wherein the type of orthogonality comprises time domain multiplex (TDM) orthogonality.

Clause 48. The network node of clause 47, wherein: the one or more capability parameters indicating the one or more capabilities of the network node comprise at least one capability parameter indicating an antenna switching delay of the network node, and the one or more configuration parameters comprise an indication, based on the type of orthogonality comprising TDM orthogonality and the antenna switching delay of the network node being less than a threshold, that the network node is expected to transmit the MIMO radar signals.

Clause 49. The network node of any of clauses 47 to 48, wherein: the one or more configuration parameters comprise an indication that the network node is expected to receive the MIMO radar signals, and the network node is expected to compensate, based on the type of orthogonality comprising TDM orthogonality, for phase shift migration before angle estimation.

Clause 50. The network node of any of clauses 45 to 49, wherein the type of orthogonality comprises Doppler domain multiplex (DDM) orthogonality.

Clause 51. The network node of clause 50, wherein, based on the type of orthogonality comprising DDM orthogonality, the one or more transmission parameters comprise a phase code for each of the MIMO radar signals.

Clause 52. The network node of any of clauses 50 to 51, wherein, based on the type of orthogonality comprising DDM orthogonality, a phase code for each of the MIMO radar signals is configured, at least in part, based on a capability of the network node related to a number of antennas of the network node capable of simultaneously transmitting the MIMO radar signals.

Clause 53. The network node of any of clauses 45 to 52, wherein the type of orthogonality comprises frequency domain multiplex (FDM) orthogonality.

Clause 54. The network node of clause 53, wherein: the one or more configuration parameters comprise an indication that the network node is expected to receive the MIMO radar signals, and based on the type of orthogonality comprising FDM orthogonality, a determination of a cutoff frequency for an antialiasing band pass filter (BPF) is based on a type of waveform of the MIMO radar signals and time resources, frequency resources, or both on which the MIMO radar signals are transmitted.

Clause 55. The network node of any of clauses 53 to 54, wherein: the one or more capability parameters indicating the one or more capabilities of the network node include at least one capability parameters indicating a number of carrier frequencies supported by the network node.

Clause 56. The network node of any of clauses 43 to 55, wherein the one or more configuration parameters comprise: a network identifier for each of one or more second network nodes involved in the bistatic or multistatic MIMO radar sensing operation, and an association, for each second network node of the one or more second network nodes, between the network identifier of the second network node and an indication of whether the second network node is a MIMO radar receiver network node or a MIMO radar transmitter network node for the bistatic or multistatic MIMO radar sensing operation.

Clause 57. The network node of any of clauses 43 to 56, wherein: the one or more configuration parameters comprise an indication that the network node is expected to transmit MIMO radar signals for the bistatic or multistatic MIMO radar sensing operation, and performing the bistatic or multistatic MIMO radar sensing operation comprises transmitting MIMO radar signals to at least one MIMO radar receiver network node.

Clause 58. The network node of any of clauses 43 to 56, wherein: the one or more configuration parameters comprise an indication that the network node is expected to receive MIMO radar signals for the bistatic or multistatic MIMO radar sensing operation, and performing the bistatic or multistatic MIMO radar sensing operation comprises receiving the MIMO radar signals from at least one MIMO radar transmitter network node.

Clause 59. The network node of any of clauses 43 to 58, wherein: the network node is a user equipment (UE), or the network node is a base station.

Clause 60. A network entity, comprising: means for receiving, from each network node of a plurality of network nodes, a capability message including one or more capability parameters indicating one or more capabilities of the network node to participate in bistatic or multistatic multiple-input multiple-output (MIMO) radar sensing operations; and means for transmitting, to each network node of the plurality of network nodes, a configuration message including one or more configuration parameters configuring the network node to participate in a bistatic or multistatic MIMO radar sensing operation.

Clause 61. The network entity of clause 60, further comprising: means for selecting at least one network node of the plurality of network nodes as a MIMO radar transmitter network node based on the one or more capability parameters indicating the one or more capabilities of the at least one network node, wherein the one or more configuration parameters comprise an indication that the at least one network node is expected to transmit MIMO radar signals.

Clause 62. The network entity of any of clauses 60 to 61, further comprising: means for selecting at least one network node of the plurality of network nodes as a MIMO radar receiver network node based on the one or more capability parameters indicating the one or more capabilities of the at least one network node, wherein the one or more configuration parameters comprise an indication that the at least one network node is expected to receive MIMO radar signals.

Clause 63. The network entity of any of clauses 60 to 62, wherein: the network entity is an entity in a radio access network (RAN), the network entity is an entity in a core network, or the network entity is an entity external to the core network.

Clause 64. A non-transitory computer-readable medium storing computer-executable instructions that, when executed by a network node, cause the network node to: transmit, to a network entity, a capability message including one or more capability parameters indicating one or more capabilities of the network node to participate in bistatic or multistatic multiple-input multiple-output (MIMO) radar sensing operations; receive, from the network entity, a configuration message including one or more configuration parameters configuring the network node to participate in a bistatic or multistatic MIMO radar sensing operation; and perform the bistatic or multistatic MIMO radar sensing operation based on the one or more configuration parameters.

Clause 65. The non-transitory computer-readable medium of clause 64, wherein the one or more configuration parameters comprise one or more transmission parameters for MIMO radar signals to be transmitted during the bistatic or multistatic MIMO radar sensing operation.

Clause 66. The non-transitory computer-readable medium of clause 65, wherein the one or more transmission parameters comprise: a type of orthogonality of the MIMO radar signals, a type of the MIMO radar signals, one or more parameters defining a waveform of each of the MIMO radar signals, or any combination thereof.

Clause 67. The non-transitory computer-readable medium of clause 66, wherein the type of the MIMO radar signals comprises: frequency modulated continuous wave (FMCW) MIMO radar signals, or orthogonal frequency division multiplexing (OFDM) MIMO radar signals.

Clause 68. The non-transitory computer-readable medium of any of clauses 66 to 67, wherein the type of orthogonality comprises time domain multiplex (TDM) orthogonality.

Clause 69. The non-transitory computer-readable medium of clause 68, wherein: the one or more capability parameters indicating the one or more capabilities of the network node comprise at least one capability parameter indicating an antenna switching delay of the network node, and the one or more configuration parameters comprise an indication, based on the type of orthogonality comprising TDM orthogonality and the antenna switching delay of the network node being less than a threshold, that the network node is expected to transmit the MIMO radar signals.

Clause 70. The non-transitory computer-readable medium of any of clauses 68 to 69, wherein: the one or more configuration parameters comprise an indication that the network node is expected to receive the MIMO radar signals, and the network node is expected to compensate, based on the type of orthogonality comprising TDM orthogonality, for phase shift migration before angle estimation.

Clause 71. The non-transitory computer-readable medium of any of clauses 66 to 70, wherein the type of orthogonality comprises Doppler domain multiplex (DDM) orthogonality.

Clause 72. The non-transitory computer-readable medium of clause 71, wherein, based on the type of orthogonality comprising DDM orthogonality, the one or more transmission parameters comprise a phase code for each of the MIMO radar signals.

Clause 73. The non-transitory computer-readable medium of any of clauses 71 to 72, wherein, based on the type of orthogonality comprising DDM orthogonality, a phase code for each of the MIMO radar signals is configured, at least in part, based on a capability of the network node related to a number of antennas of the network node capable of simultaneously transmitting the MIMO radar signals.

Clause 74. The non-transitory computer-readable medium of any of clauses 66 to 73, wherein the type of orthogonality comprises frequency domain multiplex (FDM) orthogonality.

Clause 75. The non-transitory computer-readable medium of clause 74, wherein: the one or more configuration parameters comprise an indication that the network node is expected to receive the MIMO radar signals, and based on the type of orthogonality comprising FDM orthogonality, a determination of a cutoff frequency for an antialiasing band pass filter (BPF) is based on a type of waveform of the MIMO radar signals and time resources, frequency resources, or both on which the MIMO radar signals are transmitted.

Clause 76. The non-transitory computer-readable medium of any of clauses 74 to 75, wherein: the one or more capability parameters indicating the one or more capabilities of the network node include at least one capability parameters indicating a number of carrier frequencies supported by the network node.

Clause 77. The non-transitory computer-readable medium of any of clauses 64 to 76, wherein the one or more configuration parameters comprise: a network identifier for each of one or more second network nodes involved in the bistatic or multistatic MIMO radar sensing operation, and an association, for each second network node of the one or more second network nodes, between the network identifier of the second network node and an indication of whether the second network node is a MIMO radar receiver network node or a MIMO radar transmitter network node for the bistatic or multistatic MIMO radar sensing operation.

Clause 78. The non-transitory computer-readable medium of any of clauses 64 to 77, wherein: the one or more configuration parameters comprise an indication that the network node is expected to transmit MIMO radar signals for the bistatic or multistatic MIMO radar sensing operation, and performing the bistatic or multistatic MIMO radar sensing operation comprises transmitting MIMO radar signals to at least one MIMO radar receiver network node.

Clause 79. The non-transitory computer-readable medium of any of clauses 64 to 77, wherein: the one or more configuration parameters comprise an indication that the network node is expected to receive MIMO radar signals for the bistatic or multistatic MIMO radar sensing operation, and performing the bistatic or multistatic MIMO radar sensing operation comprises receiving the MIMO radar signals from at least one MIMO radar transmitter network node.

Clause 80. The non-transitory computer-readable medium of any of clauses 64 to 79, wherein: the network node is a user equipment (UE), or the network node is a base station.

Clause 81. A non-transitory computer-readable medium storing computer-executable instructions that, when executed by a network entity, cause the network entity to: receive, from each network node of a plurality of network nodes, a capability message including one or more capability parameters indicating one or more capabilities of the network node to participate in bistatic or multistatic multiple-input multiple-output (MIMO) radar sensing operations; and transmit, to each network node of the plurality of network nodes, a configuration message including one or more configuration parameters configuring the network node to participate in a bistatic or multistatic MIMO radar sensing operation.

Clause 82. The non-transitory computer-readable medium of clause 81, further comprising computer-executable instructions that, when executed by the network entity, cause the network entity to: select at least one network node of the plurality of network nodes as a MIMO radar transmitter network node based on the one or more capability parameters indicating the one or more capabilities of the at least one network node, wherein the one or more configuration parameters comprise an indication that the at least one network node is expected to transmit MIMO radar signals.

Clause 83. The non-transitory computer-readable medium of any of clauses 81 to 82, further comprising computer-executable instructions that, when executed by the network entity, cause the network entity to: select at least one network node of the plurality of network nodes as a MIMO radar receiver network node based on the one or more capability parameters indicating the one or more capabilities of the at least one network node, wherein the one or more configuration parameters comprise an indication that the at least one network node is expected to receive MIMO radar signals.

Clause 84. The non-transitory computer-readable medium of any of clauses 81 to 83, wherein: the network entity is an entity in a radio access network (RAN), the network entity is an entity in a core network, or the network entity is an entity external to the core network.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless environment sensing performed by a network node, comprising:
transmitting, to a network entity, a capability message including one or more capability parameters indicating one or more capabilities of the network node to participate in bistatic or multistatic multiple-input multiple-output (MIMO) radar sensing operations;
receiving, from the network entity, a configuration message including one or more configuration parameters configuring the network node to participate in a bistatic or multistatic MIMO radar sensing operation; and
performing the bistatic or multistatic MIMO radar sensing operation based on the one or more configuration parameters.

2. The method of claim 1, wherein the one or more configuration parameters comprise one or more transmission parameters for MIMO radar signals to be transmitted during the bistatic or multistatic MIMO radar sensing operation.

3. The method of claim 2, wherein the one or more transmission parameters comprise:
a type of orthogonality of the MIMO radar signals,
a type of the MIMO radar signals,
one or more parameters defining a waveform of each of the MIMO radar signals, or
any combination thereof.

4. The method of claim 3, wherein the type of the MIMO radar signals comprises:
frequency modulated continuous wave (FMCW) MIMO radar signals, or
orthogonal frequency division multiplexing (OFDM) MIMO radar signals.

5. The method of claim 3, wherein the type of orthogonality comprises time domain multiplex (TDM) orthogonality.

6. The method of claim 5, wherein:
the one or more capability parameters indicating the one or more capabilities of the network node comprise at least one capability parameter indicating an antenna switching delay of the network node, and
the one or more configuration parameters comprise an indication, based on the type of orthogonality comprising TDM orthogonality and the antenna switching delay of the network node being less than a threshold, that the network node is expected to transmit the MIMO radar signals.

7. The method of claim 5, wherein:
the one or more configuration parameters comprise an indication that the network node is expected to receive the MIMO radar signals, and
the network node is expected to compensate, based on the type of orthogonality comprising TDM orthogonality, for phase shift migration before angle estimation.

8. The method of claim 3, wherein the type of orthogonality comprises Doppler domain multiplex (DDM) orthogonality.

9. The method of claim 8, wherein, based on the type of orthogonality comprising DDM orthogonality, the one or more transmission parameters comprise a phase code for each of the MIMO radar signals.

10. The method of claim 8, wherein, based on the type of orthogonality comprising DDM orthogonality, a phase code for each of the MIMO radar signals is configured, at least in part, based on a capability of the network node related to a number of antennas of the network node capable of simultaneously transmitting the MIMO radar signals.

11. The method of claim 3, wherein the type of orthogonality comprises frequency domain multiplex (FDM) orthogonality.

12. The method of claim 11, wherein:
the one or more configuration parameters comprise an indication that the network node is expected to receive the MIMO radar signals, and
based on the type of orthogonality comprising FDM orthogonality, a determination of a cutoff frequency for an antialiasing band pass filter (BPF) is based on a type of waveform of the MIMO radar signals and time resources, frequency resources, or both on which the MIMO radar signals are transmitted.

13. The method of claim 11, wherein:
the one or more capability parameters indicating the one or more capabilities of the network node include at least one capability parameters indicating a number of carrier frequencies supported by the network node.

14. The method of claim 1, wherein the one or more configuration parameters comprise:
a network identifier for each of one or more second network nodes involved in the bistatic or multistatic MIMO radar sensing operation, and
an association, for each second network node of the one or more second network nodes, between the network identifier of the second network node and an indication of whether the second network node is a MIMO radar receiver network node or a MIMO radar transmitter network node for the bistatic or multistatic MIMO radar sensing operation.

15. The method of claim 1, wherein:
the one or more configuration parameters comprise an indication that the network node is expected to transmit MIMO radar signals for the bistatic or multistatic MIMO radar sensing operation, and
performing the bistatic or multistatic MIMO radar sensing operation comprises transmitting MIMO radar signals to at least one MIMO radar receiver network node.

16. The method of claim 1, wherein:
the one or more configuration parameters comprise an indication that the network node is expected to receive MIMO radar signals for the bistatic or multistatic MIMO radar sensing operation, and
performing the bistatic or multistatic MIMO radar sensing operation comprises receiving the MIMO radar signals from at least one MIMO radar transmitter network node.

17. The method of claim 1, wherein:
the network node is a user equipment (UE), or
the network node is a base station.

18. A method of environment sensing performed by a network entity, comprising:
receiving, from each network node of a plurality of network nodes, a capability message including one or more capability parameters indicating one or more capabilities of the network node to participate in bistatic or multistatic multiple-input multiple-output (MIMO) radar sensing operations; and
transmitting, to each network node of the plurality of network nodes, a configuration message including one or more configuration parameters configuring the network node to participate in a bistatic or multistatic MIMO radar sensing operation.

19. The method of claim 18, further comprising:
selecting at least one network node of the plurality of network nodes as a MIMO radar transmitter network node based on the one or more capability parameters indicating the one or more capabilities of the at least one network node,
wherein the one or more configuration parameters comprise an indication that the at least one network node is expected to transmit MIMO radar signals.

20. The method of claim 18, further comprising:
selecting at least one network node of the plurality of network nodes as a MIMO radar receiver network node based on the one or more capability parameters indicating the one or more capabilities of the at least one network node,
wherein the one or more configuration parameters comprise an indication that the at least one network node is expected to receive MIMO radar signals.

21. The method of claim 18, wherein:
the network entity is an entity in a radio access network (RAN),
the network entity is an entity in a core network, or
the network entity is an entity external to the core network.

22. A network node, comprising:
a memory;
at least one transceiver; and
at least one processor communicatively coupled to the memory and the at least one transceiver, the at least one processor configured to:
transmit, via the at least one transceiver, to a network entity, a capability message including one or more capability parameters indicating one or more capabilities of the network node to participate in bistatic or multistatic multiple-input multiple-output (MIMO) radar sensing operations;
receive, via the at least one transceiver, from the network entity, a configuration message including one or more configuration parameters configuring the network node to participate in a bistatic or multistatic MIMO radar sensing operation; and
perform the bistatic or multistatic MIMO radar sensing operation based on the one or more configuration parameters.

23. The network node of claim 22, wherein the one or more configuration parameters comprise one or more transmission parameters for MIMO radar signals to be transmitted during the bistatic or multistatic MIMO radar sensing operation.

24. The network node of claim 23, wherein the one or more transmission parameters comprise:
a type of orthogonality of the MIMO radar signals,
a type of the MIMO radar signals,
one or more parameters defining a waveform of each of the MIMO radar signals, or
any combination thereof.

25. The network node of claim 22, wherein the one or more configuration parameters comprise:
a network identifier for each of one or more second network nodes involved in the bistatic or multistatic MIMO radar sensing operation, and
an association, for each second network node of the one or more second network nodes, between the network identifier of the second network node and an indication of whether the second network node is a MIMO radar receiver network node or a MIMO radar transmitter network node for the bistatic or multistatic MIMO radar sensing operation.

26. The network node of claim 22, wherein:
the one or more configuration parameters comprise an indication that the network node is expected to transmit MIMO radar signals for the bistatic or multistatic MIMO radar sensing operation, and
performing the bistatic or multistatic MIMO radar sensing operation comprises transmitting MIMO radar signals to at least one MIMO radar receiver network node.

27. The network node of claim 22, wherein:
the one or more configuration parameters comprise an indication that the network node is expected to receive MIMO radar signals for the bistatic or multistatic MIMO radar sensing operation, and
performing the bistatic or multistatic MIMO radar sensing operation comprises receiving the MIMO radar signals from at least one MIMO radar transmitter network node.

28. A network entity, comprising:
a memory;
at least one transceiver; and
at least one processor communicatively coupled to the memory and the at least one transceiver, the at least one processor configured to:
receive, via the at least one transceiver, from each network node of a plurality of network nodes, a capability message including one or more capability parameters indicating one or more capabilities of the network node to participate in bistatic or multistatic multiple-input multiple-output (MIMO) radar sensing operations; and
transmit, via the at least one transceiver, to each network node of the plurality of network nodes, a configuration message including one or more configuration parameters configuring the network node to participate in a bistatic or multistatic MIMO radar sensing operation.

29. The network entity of claim 28, wherein the at least one processor is further configured to:
select at least one network node of the plurality of network nodes as a MIMO radar transmitter network node based on the one or more capability parameters indicating the one or more capabilities of the at least one network node,
wherein the one or more configuration parameters comprise an indication that the at least one network node is expected to transmit MIMO radar signals.

30. The network entity of claim 28, wherein the at least one processor is further configured to:
select at least one network node of the plurality of network nodes as a MIMO radar receiver network node based on the one or more capability parameters indicating the one or more capabilities of the at least one network node,
wherein the one or more configuration parameters comprise an indication that the at least one network node is expected to receive MIMO radar signals.
